(19) United States
(12) Patent Application Publication
(10) Pub. No.: US 2022/0208011 A1
(43) Pub. Date: Jun. 30, 2022

(54) Cloud Based Flight Management Computation

(71) Applicant: SMARTSKY NETWORKS LLC, Morrisville, NC (US)

(72) Inventors: Bruce J. Holmes, Williamsburg, VA (US); Elbert Stanford Eskridge, JR., Chapel Hill, NC (US); James Evans Ladd, JR., Hillsborough, NC (US)

(21) Appl. No.: 17/605,841

(22) PCT Filed: Apr. 22, 2020
(86) PCT No.: PCT/US2020/029330

§ 371 Date: Oct. 22, 2021

Related U.S. Application Data
(60) Provisional application No. 62/837,556, filed on Apr. 23, 2019.

(51) Int. Cl. G08G 5/00; H04W 4/42

(52) U.S. Cl. CPC G08G 5/0013; G08G 5/0039; H04W 4/42; G08G 5/0026; G08G 5/0021

(57) ABSTRACT

A method of providing a cloud-based flight management system (FMS) may include receiving an input to a flight management computer (FMC) client in an airborne aircraft indicative of a need for FMS data, communicating a request for the FMS data to a FMS management module located remotely from the airborne aircraft via a wireless communication network, receiving a response to the request at the FMC client of the airborne aircraft via the wireless communication network, and, based on the response, generating an output on the airborne aircraft via the FMC client.

### CROSS REFERENCE TO RELATED APPLICATIONS

This application claims priority to U.S. application number 62/837,556, filed on Apr. 23, 2020, the entire contents of which are hereby incorporated by reference in its entirety.

### TECHNICAL FIELD

Example embodiments generally relate to wireless communications and, more particularly, relate to providing flight management system (FMS) services using a thin airborne client based on reliable connection to the ground. Other instantiations of these wireless services can apply in autopilots; Full-Authority Digital Electronic Controls (FADEC) for engines; other aircraft management systems; cabin technical and passenger systems; and vehicle-to-vehicle flight coordination systems.

### BACKGROUND

An FMS is a computer system that is onboard an aircraft (whether manned or unmanned) and is specially designed to automate certain tasks in order to make the workload of the flight crew, flight operations dispatchers, and air traffic controllers more manageable. In particular, if given a flight plan, the FMS can use sensors to determine aircraft position (along with other flight parameters) and guide the aircraft along the flight plan. In a typical situation, the FMS includes a flight management computer (FMC) and a control display unit (CDU), which is provided in the aircraft for user interface capability. The FMC manages various other components of the FMS including navigational components, flight and instrument displays, flight control systems, engine and fuel systems, data link, etc. The FMC therefore provides the primary means of controlling functions associated with navigation, flight planning, route guidance, trajectory prediction, etc. Controlling these functions typically requires interaction with various databases associated with navigation, basic operations and engine/aircraft performance data.

The database associated with navigation is called a navigation database, or NDB. The NDB is used for building and processing flight plans. The NDB (like the other databases) is stored in the FMC on a read-only memory device that is updated via a data loader. The data stored in the NDB (i.e., NDB data or information) includes waypoints, airways, runway information, holding patterns, and numerous other important aids to navigation and instructions. As may be expected, this information is continuously both changing and expanding, and therefore needs routine updating. Nominally, for commercial airlines, the data is updated every 28 days with a managed update that is subject to regulation and results in the FMS essentially turning into a sealed box of certified hardware and software that cannot be easily updated. The managed update is handled as a maintenance activity that is conducted while the aircraft is on the ground.

Beyond the problem of creating a sealed box that is difficult to update, the databases associated with the FMC continue to grow in size, with no limit in sight. The continued growth of the size of the databases means that memory requirements also increase. Although an airline can request databases with limited geographic area coverage, so that the database size can be limited. However, defining tradeoffs in scope of area against a limited memory capacity necessarily impacts the detail level of the information that can be stored as well. Moreover, having aircraft that include databases with limited geographic region coverage also means those aircraft are restricted to operation in areas that are entirely covered by their databases. This can restrict scheduling flexibility since the aircraft are restricted to specific regions.

Further limiting the flexible updating of FMS capabilities, the certified software and operating system (OS) built into the sealed FMS hardware prevents convenient modification of those components, such as those occurring as improvements occur in technology for airspace and data management. The evolution of open, service-oriented architectures for algorithm and data services, such as through the SmartSky Networks Skytelligence™ Aviation Data Marketplace, offer an example of a means for supplying new data, software, and OS improvements over wireless connectivity. These improvements could be certified in one central system, then distributed throughout the fleet of cloud-based FMS airborne units, saving time and money, while accelerating safety- and efficiency-enhancing changes.

Accordingly, it may be desirable to break the current cycle of reliance on a limited capability for interaction with what is effectively a sealed box that creates restrictions on the operation of the aircraft until the next rigidly managed update can be accomplished.

### BRIEF SUMMARY OF SOME EXAMPLES

Some example embodiments may provide a mechanism by which to define a flight management computation capability that is cloud-based. In this regard, by defining assured reliability of airborne communications, and security of such communications, the FMS may essentially operate as an airborne, thin client that interacts with cloud-based services. This arrangement can avoid rigid and limiting hardware, software, and OS updates and make the FMS responsive to in-service updates that can minimize the amount of on-board storage required, and provide prompt updating capabilities that maximize the flexibility of the aircraft.

In one example embodiment, a cloud-based flight management system is provided. The system may include an FMS management module operably coupled to a wireless communication network on the ground, and an FMC client disposed at an aircraft including radio equipment configured to communicate via the wireless communication network while the aircraft is in flight. The FMS management module is configured to store FMS data including at least NDB information. At least some of the FMS data may be provided from the FMS management module to the FMC client while the aircraft is in flight.

In another example embodiment, a method of providing a cloud-based flight management system (FMS) is provided. The method may include receiving an input to a flight management computer (FMC) client in an airborne aircraft indicative of a need for FMS data, communicating a request for the FMS data to a FMS management module located remotely from the airborne aircraft via a wireless communication network, receiving a response to the request at the FMC client of the airborne aircraft via the wireless communication network, and, based on the response, generating an output on the airborne aircraft via the FMC client. These connections may be over Air-to-Ground (ATG), Air-to-Air (ATA), or Air-to-Satellite (ATS) connectivity.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a system in accordance with an example embodiment;

FIG. 2 illustrates a block diagram of an FMC management module in accordance with an example embodiment;

FIG. 3 illustrates a block diagram of an FMC client in accordance with an example embodiment;

FIG. 4 illustrates a functional block diagram of a method according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions.

Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide a system, architectures and/or methods for improved FMS (and/or FMC) updating. In this regard, some example embodiments may provide a system that provides reliable, continuous and real-time connectivity to aircraft. This level of reliable connectivity may enable a reliance on storing large amounts of data locally, or maintaining unchanging software onboard the aircraft, to become a thing of the past. Having a reliable and secure connection to the ground, either at all times or when the aircraft is at altitude, can make it possible (and advisable) to place an engine for FMS in the cloud, and virtually eliminate the requirement for large amounts of highly inaccessible data storage on the aircraft. This eliminates all restrictions on aircraft flexibility for scheduling since literally any NDB data for any geographical area, and with any level of detail, can be provided to the aircraft at any time. Moreover, cost indexing and other advanced functions may be integrated into FMS so that, for example, fuel burn profiles can be optimized from a Flight Operations dispatch center for journeys on the fly, and in consideration of real-time and forecast conditions.

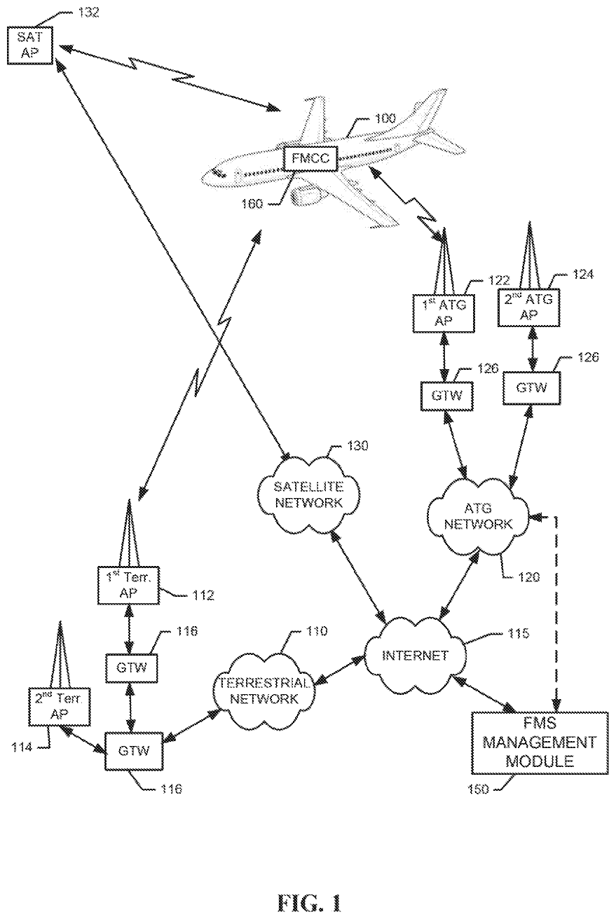

FIG. 1 illustrates a block diagram of various components of a system, which may include one or more wireless communication networks that may be employed to communicate with an aircraft 100 according to an example embodiment. In this regard, as shown in FIG. 1, a terrestrial network 110, an ATG network 120 and a satellite network 130 are each represented. However, it should be appreciated that example embodiments could be employed with only one such network, with two of the networks, or even with other networks capable of communication with the aircraft 100.

As shown in FIG. 1, each of the wireless communication networks may include wireless access points (APs) that include antennas configured for wireless communication. Thus, for example, the terrestrial network 110 may include a first terrestrial AP 112 and a second terrestrial AP 114, each of which may be base stations, among a plurality of geographically distributed base stations that combine to define the coverage area for the terrestrial network 110. The first and second terrestrial APs 112 and 114 may each be examples of terrestrial base stations that are placed adjacent to each other to provide coverage in overlapping cells that each extend outwardly from the respective base stations in substantially all directions. Thus, the terrestrial base stations may provide a constant layer of coverage near the ground and up to a maximum altitude.

The first and second terrestrial APs 112 and 114 may each be in communication with the terrestrial network 110 via a gateway (GTW) device 116. The terrestrial network 110 may further be in communication with a wide area network such as the Internet 115, Virtual Private Networks (VPNs) or other communication networks. In some embodiments, the terrestrial network 110 may include or otherwise be coupled to a packet-switched core or other telecommunications network. Thus, for example, the terrestrial network 110 may be a cellular telephone network (e.g., a 4G, 5G, LTE or other such network).

The ATG network 120 may similarly include a first ATG AP 122 and a second ATG AP 124, each of which may be base stations, among a plurality of geographically distributed base stations that combine to define the coverage area for the ATG network 120. The first and second ATG APs 122 and 124 may each be in communication with the ATG network 120 via a GTW device 126. The ATG network 120 may also be in communication with a wide area network such as the Internet 115, VPNs or other communication networks. In some embodiments, the ATG network 120 may also include or otherwise be coupled to a packet-switched core or other telecommunications network. Thus, for example, the ATG network 120 may be a network that is configured to provide wireless communication to airborne assets and may employ 4G, 5G, LTE and/or other proprietary technologies. The ATG network 120 may include base stations that define a coverage area substantially above a minimum altitude, which may or may not overlap with the maximum altitude defined by the terrestrial network 110. Moreover, in some cases, the ATG network 120 may be configured to employ beamforming technology that involves either steering narrow beams between the aircraft 100 and the base stations of the ATG network (e.g., the first and second ATG APs 122 and 124) or forming selected ones of a plurality of fixed beams that are each oriented in adjacent and overlapping areas to define full zones of coverage that also overlap. In an example embodiment, the ATG network 120 may be configured to employ unlicensed band frequencies to massively increase the bandwidth capability of the ATG network 120 beyond that of licensed band communications. Moreover, the ATG network 120 may be bidirectional in nature, such that high bandwidths and low latencies can be achieved in both directions. For example, the ATG network 120 may be capable of delivering download speeds (to the aircraft 100) of greater than 4 Mbps and an upload speed (from the aircraft 100) of greater than 1 Mbps along with latency of less than 100 ms and a jitter of less than 10,000 ms.

The satellite network 130 may include one or more ground stations and one or more satellite access points 132 (including satelites in Low Earth Orbit (LEO)). The satellite network 130 may employ Ka band, Ku band, or any other suitable satellite frequencies/technologies to provide wireless communication services to the aircraft 100 either while in-flight, or on the ground. Although the satellite network 130 may have good download speeds, upload speeds can be poorer, and latency will be a significant problem for orbits above LEO. Accordingly, the ATG network 120 may be preferred to satellite communications via the satellite network 130 whenever the ATG network 120 is accessible (e.g., due to altitude limitations). However, the satellite network 130 may be a reliable or useful alternative to the ATG network 120 in some cases.

As shown in FIG. 1, an FMS management module 150 may be disposed at a location accessible to one or more of the networks. Thus, for example, the FMS management module 150 may be operably coupled to the Internet 115. However, the FMS management module 150 may be disposed at a particular one of the networks (e.g., the ATG network 120) in some cases. The FMS management module 150 may be configured to provide FMS data (e.g., NDB data) to a FMC client 160 disposed on the aircraft 100. Moreover, it should be appreciated that the FMS management module 150 may be configured to communicate (including simultaneously) with many aircraft and with many individual instances of FMC clients on each respective one of the aircraft. Thus, the FMS management module 150 may be configured to supply FMS data including NDB data to many aircraft associated with a particular airline, or with multiple different airlines, as described herein. Then, the FMC client of each respective aircraft can use the FMS data as described herein for route planning, fuel optimization, dynamic Trajectory Based Operations (TBO), and other purposes while the aircraft are in-flight.

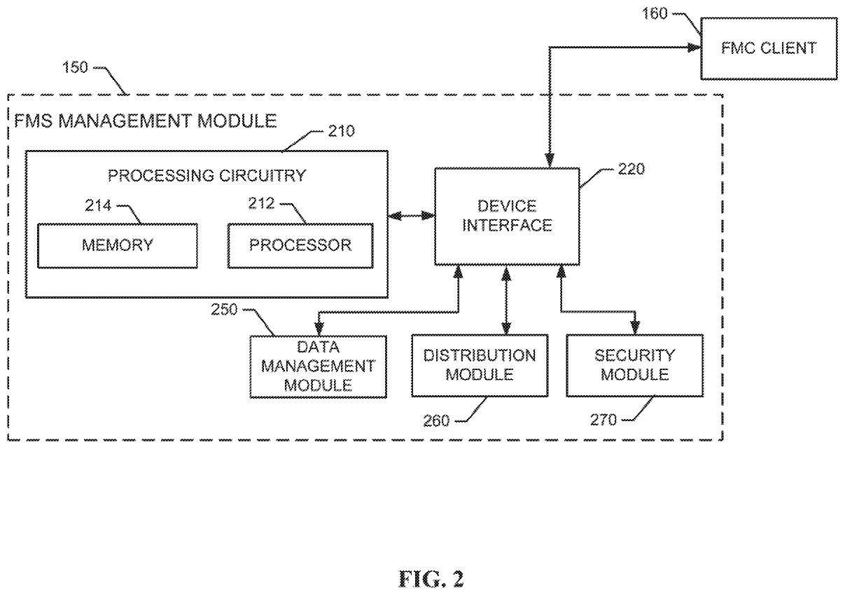

An example structure for the FMS management module 150 of an example embodiment is shown in the block diagram of FIG. 2. In this regard, as shown in FIG. 2, the FMS management module 150 may include processing circuitry 210 configured to perform data processing, control function execution and/or other processing and management services according to an example embodiment of the present invention. In some embodiments, the processing circuitry 210 may be embodied as a chip or chip set. In other words, the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 210 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 210 may include one or more instances of a processor 212 and memory 214 that may be in communication with or otherwise control a device interface 220. As such, the processing circuitry 210 may be embodied as a circuit chip (e.g., an integrated circuit chip) configured (e.g., with hardware, software or a combination of hardware and software) to perform operations described herein. In some embodiments, the processing circuitry 210 may communicate with various internal and/or external components, entities, modules and/or the like, e.g., via the device interface 220. The processing circuitry 210 may also communicate with one or more instances of the FMC client 160 via one of the networks (and more specifically, via an antenna assembly and/or radio that is configured to wirelessly interface with an aircraft via the corresponding one of the networks). In this regard, the processing circuitry 210 may act as the server for handling a majority of the memory and processing power requirements associated with FMS and some other services remotely from the aircraft 100.

The device interface 220 may include one or more interface mechanisms for enabling communication with other internal and/or external devices (e.g., modules, entities, sensors and/or other components of the networks and/or aircraft). In some cases, the device interface 220 may be any means such as a device or circuitry embodied in either hardware, or a combination of hardware and software that is configured to receive and/or transmit data from/to modules, entities, sensors and/or other components of the networks and/or aircraft that are in communication with the processing circuitry 210. In this regard, for example, the device interface 220 may be configured to operably couple the processing circuitry 210 to a data management module 250, a distribution module 260, and an security module 270.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform the operations described herein.

In an example embodiment, the processor 212 (or the processing circuitry 210) may be embodied as, include or otherwise control the operation of the data management module 250, the distribution module 260, and the security module 270. As such, in some embodiments, the processor 212 (or the processing circuitry 210) may be said to cause each of the operations described in connection with the data management module 250, the distribution module 260, and the security module 270. The processor 212 may also control function execution and instruction provision related to operations of the data management module 250, the distribution module 260, and the security module 270 based on execution of instructions or algorithms configuring the processor 212 (or processing circuitry 210) accordingly. In particular, the instructions may include instructions for determining which information and/or services to provide to a particular aircraft, and then the provision of such information and/or services with appropriate security in place.

In an exemplary embodiment, the memory 214 may include one or more non-transitory memory devices such as, for example, volatile and/or non-volatile memory that may be either fixed or removable. The memory 214 may be configured to store information, data, applications, instructions or the like for enabling the processing circuitry 210 to carry out various functions in accordance with exemplary embodiments of the present invention. For example, the memory 214 could be configured to buffer input data for processing by the processor 212. Additionally or alternatively, the memory 214 could be configured to store instructions for execution by the processor 212. As yet another alternative, the memory 214 may include one or more databases that may store a variety of data sets associated with the data management module 250 (e.g., NDB information or data). Among the contents of the memory 214, applications and/or instructions may be stored for execution by the processor 212 in order to carry out the functionality associated with each respective application/instruction.

The data management module 250 may be configured to receive NDB and other information associated with the FMS and store such information in a way that enables specific portions of such information to be requested, disseminated, updated, launched, executed, and/or the like. Thus, for example, maps, weather data, waypoints, airways, runway information, holding pattern information (or routes), aids to navigation, etc. may be stored in association with respective geographic areas, airports, and/or the like, and such contents may be provided to the aircraft 100 while in flight, or may be used in association with applications where processing is mostly done on the ground and corresponding functions can be driven remotely through connectivity with the ground. However, in some cases, the data management module 250 may further include stored information associated with applications or services that may be accessible to an inflight aircraft via the distribution module 260, either as part of remotely provided software packages that can be provided or updated while the aircraft 100 is in flight, or entirely as services or applications launched and executed on the ground, but powering the aircraft 100 to perform corresponding functions while in flight.

All information stored in the data management module 250 may be stored only after authorized access to the data management module 250 has been granted by the security module 270 as described below. Accordingly, all information stored in the data management module 250 may be authentic information provided only by authorized sources that are known and trusted within the system. Data stored in the data management module 250 may, in some cases, be associated with a specific airline, aircraft, FMS service provider, subscription service, etc., so that, for example, all data updates or replacements can accurately be stored in a manner that permits easy further updating and dissemination by and to the correct/authorized parties.

The distribution module 260 may be configured to interface with the FMC client 160 to distribute (e.g., wirelessly via one of the networks of FIG. 1) data or content from the data management module 250 to the FMC client 160 of one or more instances of the aircraft 100. In some cases, the distribution module 260 may receive information from the FMC client 160 indicating inputs by the pilot(s) of the aircraft 100, and may provide selected NDB data corresponding to the inputs, or may process NDB data via the processing circuitry 210 using applications stored on the ground to serve content to the aircraft 100 (and particularly to the FMC client 160). For example, if the inputs include an identification of a destination or waypoint, the distribution module 260 may retrieve detailed map data, weather data or other NDB data that is specific to the destination or waypoint that has been input from the data management module 250. The retrieved information or data may then be communicated wirelessly to the FMC client 160 for the provision of guidance information or control inputs as would normally be performed by the FMC of the aircraft 100 using entirely locally stored information by the last 28-day update process. Alternatively, the retrieved information can be processed by the processing circuitry 210 on the ground, in connection with sensor and location information provided from the aircraft 100 in real time and resulting content can be provided back to the aircraft 100 as control or guidance information. Thus, a major difference between conventional FMS update methods is the fact that the NDB data (and any FMS data) can be stored remotely from the aircraft 100 and provided to the aircraft 100 wirelessly. Moreover, the NDB data (or any FMS data) can be updated in real time and provided to the aircraft 100 while the aircraft 100 is in flight. Furthermore, in at least some cases, processing associated with the functions performed based on the NDB data or FMS data may also occur on the ground so a relatively light hardware suite on the aircraft 100 can be employed to serve content to the crew or pilot.

As may be appreciated from the discussion above, security of the information stored in and provided from the data management module 250 is of great significance. Care must be taken to ensure that data stored in the data management module 250 can only be stored, updated or provided by authorized sources. Care must also be taken to ensure that requests for such information must be authentically received by the aircraft that are identified as the source of such requests. Finally, information received at the aircraft 100 must be able to be reliably confirmed as being provided from the data management module 250 and not some other source. To accomplish these security related functions, the security module 270 may be employed.

Further, in a Vehicle-to-Vehicle (V2V) instantiation of flight path management employing cloud-based FMS functions, the system includes check on compatibility between two vehicles' database and software versions, to ensure safety of flight.

The security module 270 may be configured to restrict access to storing information in the data management module 250 to only authorized users by requiring such users to authenticate their identities when a request to store, update or otherwise provide information into the data management module 250 is received. In some cases, an entity with access to the data management module 250 may obtain access by registering and receiving one or more usernames and corresponding passwords. The entity may therefore be required to submit a valid username and password in order to access the data management module 250. Additionally or alternatively, the entity may register with contact information such that, upon requesting access to the data management module 250, an access code may be sent to the entity based on the contact information provided. The access code may then be submitted in order to authenticate the entity prior to granting access to the data management module 250. Other authentication paradigms may also be employed in some cases prior to granting access to the data management module 250. For example, all communications between the FMS management module 150 and the FMC client 160 may be encrypted in some cases.

After changes are submitted by an authorized entity to the data management module 250, the data (e.g., NDB data and other services) in the data management module 250 may be available for delivery to aircraft in response to information indicative of a need to provide the data. The information indicative of a need to provide the data may be a request for such data or a request for a service or information that requires delivery of the data. The request may, in some cases, be an input of a destination or other flight plan information that requires supporting NDB data or other information or services in order to support fulfillment of the request. However, the information indicative of a need to provide the data may also come from the entity that stores the data in the data management module 250 as well. Thus, data can either be pushed to aircraft or requested by aircraft, or a combination thereof Moreover, due to the ability to provide seamless communication with the aircraft 100 while the aircraft 100 is in flight, the aircraft 100 (and more specifically the FMC client 160) need not store large portions of NDB data or other FMS data onboard the aircraft 100. Instead, the aircraft 100 can conduct bidirectional, high bandwidth communications with the FMS management module 150 to receive necessary data either in real time or to receive flight plan related information during the flight for which the flight plan related information is relevant.

In some embodiments, the entity that is authorized to submit data to the data management module 250, or another entity that owns, operates or manages aircraft (e.g., an airline or aviation-related services provider) may provide a list of aircraft tail numbers, or other asset identifiers to indicate the specific aircraft that can make requests or otherwise have data pushed to them. In some cases, the aircraft 100 may be required (i.e., by the security module 270) to conduct an authentication (or handshake) procedure with the FMS management module 150 before data can be communicated to the aircraft 100 from the data management module 250. Communications between the FMS management module 150 (e.g., via the distribution module 260) and a specific instance of the FMC client 160 may therefore be conducted on an individual basis with direct and targeted communications being made to the aircraft 100 based on the aircraft tail number or other asset identifier specifically associated with the aircraft 100. Moreover, the direct and targeted communications may further require authentication (or a handshake) before getting underway. The authentication may also be a two way authentication where each side must authenticate itself properly to the other. Moreover, in some cases, communications between the FMS management module 150 and the FMC client 160 may be transmitted via encoded communications that employ dynamic coding schemes with keys that are aircraft and/or flight specific.

Accordingly, instead of broadcast communications to aircraft in general, the communications between the FMS management module 150 and the FMC client 160 may be direct and targeted. This targeted communication may be both enabled and enhanced, in some cases, by the fact that the ATG network 120 of some example embodiments may be configured to utilize beamforming technology to form narrow beams between the aircraft 100 and the base stations of the ATG network (e.g., the first and second ATG APs 122 and 124). The narrow beams that are formed directly between the aircraft 100 and the base stations may also enhance security since the beams are formed with knowledge of the location of the aircraft 100 relative to the corresponding base station that is currently serving the aircraft 100. Thus, although the security module 270 may employ security measures that are actively taken to safeguard communications between the FMS management module 150 and the FMC client 160, such communications may also be inherently protected by virtue of the nature of the ATG network 120 in terms of the requisite knowledge for location of the aircraft 100 to facilitate beamforming, and therefore the assurance that the aircraft 100 in the correct location is receiving the information intended for the aircraft 100.

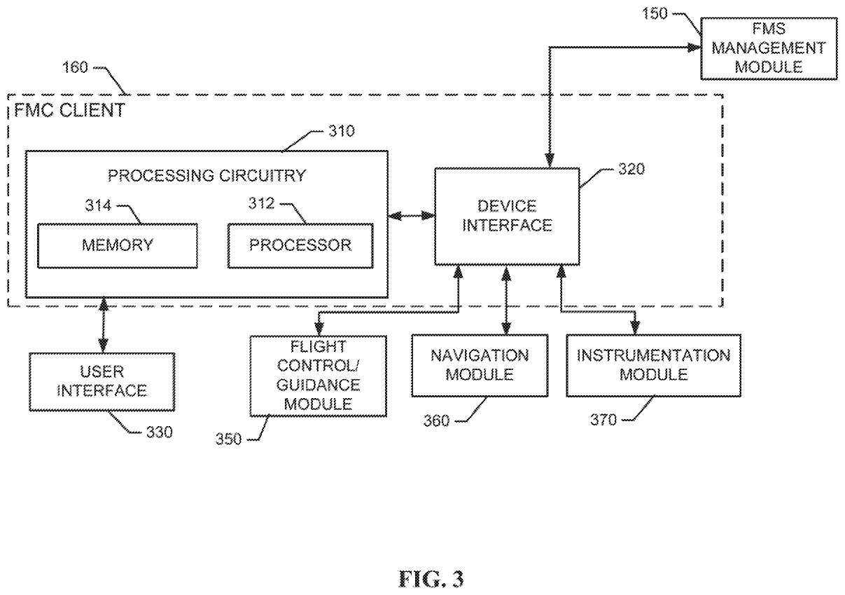

FIG. 3 illustrates a block diagram of various components of the FMC client 160 of an example embodiment. The FMC client 160 may be embodied in one of two ways in accordance with example embodiments. In one way, the FMC client 160 may be an airborne “thin client” with minimal onboard weight and components that rely on continuous, reliable, and high speed connectivity to have server based functions and processing managed on the ground (i.e., at the FMS management module 150), and have minimal processing and storage of information provided at the FMC client 160. This may be referred to as an airborne thin client configuration. In another embodiment, the FMC client 160 may have more robust processing and storage capabilities and may be configured in a dynamically updateable while airborne (DUWA) configuration. However, the storage capabilities may be substantially scaled down from typical FMS system requirements (i.e., where rigid and comprehensive NDB information is loaded into the FMS on a periodic basis) in the DUWA configuration. Thus, for example, pre-flight and in-flight updates to NDB information and other FMS data may be stored temporarily on the FMC client 160 and may be updated (securely) also periodically. In some cases, the data stored may only be for a current flight plan (or the current flight plan and the next scheduled flight plan), and therefore updates may be conducted each flight with the information necessary for the flight (and perhaps sometimes also the next flight).

In an example embodiment, the FMC client 160 may include processing circuitry 310 configured to perform data processing, control function execution and/or other processing and management services according to an example embodiment of the present invention. In some embodiments, the processing circuitry 310 may be embodied as a chip or chip set. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 320. As such, the processing circuitry 310 may be embodied as a circuit chip (e.g., an integrated circuit chip) configured (e.g., with hardware, software or a combination of hardware and software) to perform operations described herein. In some embodiments, the processing circuitry 310 may communicate with various components, entities and/or sensors of the aircraft 100, e.g., via the device interface 320. Thus, for example, the processing circuitry 310 may communicate with a sensor network (via flight control/guidance module 350) of the aircraft 100 to receive information from aircraft systems on flight control surfaces, etc., and may communicate with position sensors (e.g., GPS or inertial reference systems via navigation module 360) to receive altitude information, location information (e.g., GPS coordinates, latitude/longitude, etc.), pitch and roll information, and/or the like. The processing circuitry 310 may also communicate with the FMS management module 150 via one of the networks (and more specifically, via an antenna assembly and/or radio that is configured to wirelessly interface with the corresponding one of the networks).

The device interface 320 may include one or more interface mechanisms for enabling communication with other internal and/or external devices (e.g., modules, entities, sensors and/or other components of the networks and/or aircraft). In some cases, the device interface 320 may be any means such as a device or circuitry embodied in either hardware, or a combination of hardware and software that is configured to receive and/or transmit data from/to modules, entities, sensors and/or other components of the networks and/or aircraft that are in communication with the processing circuitry 310. In this regard, for example, the device interface 320 may be configured to operably couple the processing circuitry 310 to the flight control/guidance module 350, the navigation module 360 and an instrumentation module 370 along with the FMS management module 150.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein.

In an example embodiment, the processor 312 (or the processing circuitry 310) may be embodied as, include or otherwise control the operation of the flight control/guidance module 350, the navigation module 360 and the instrumentation module 370. As such, in some embodiments, the processor 312 (or the processing circuitry 310) may be said to cause each of the operations described in connection with the data flight control/guidance module 350, the navigation module 360 and the instrumentation module 370 or at least control the interactions of the FMC client 160 with such modules. The processor 312 may also control function execution and instruction provision related to operations of the data flight control/guidance module 350, the navigation module 360 and the instrumentation module 370 based on execution of instructions or algorithms configuring the processor 312 (or processing circuitry 310) accordingly.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments of the present invention. For example, the memory 314 could be configured to buffer input data for processing by the processor 312. Additionally or alternatively, the memory 314 could be configured to store instructions for execution by the processor 312. However, unlike a conventional FMS, the memory 314 of the FMC client 160 is not a large database storage device for storing pre-programmed routes or other NDB data by means of a data loader that is manually employed on the ground. Instead, the memory 314 is of sufficient size only to support operation of the FMC client 160 as a “thin client” that is effectively a lightweight computer that is optimized for establishing a remote connection to the FMS management module 150 to utilize the FMS management module 150 (and the memory 214 or data management module 250) thereof as a server for operation in a client-server based computing environment when the airborne thin client configuration is employed. As such, the FMS management module 150 handles most of the work associated with launching and execution of software programs, including most of the processing and data storage. Meanwhile, even when the DUWA configuration is employed, the memory 314 can still be substantially limited in size and may be optimized (in terms of the information stored therein) for the current flight (and perhaps also the next flight).

The FMC client 160 may further include a user interface 330 that may be in communication with the processing circuitry 310 to receive an indication of a user input at the user interface 330 and/or to provide an audible, visual, mechanical or other output to the user (i.e., pilot or crew member). As such, the user interface 330 may include, for example, one or more instances of a keyboard, microphone, display, levers, switches, indicator lights, touchscreens, buttons or keys (e.g., function buttons), and/or other input/output mechanisms. In some embodiments, crew of the aircraft 100, airline personnel and/or network personnel may interact with the user interface 330 to provide information that may be used to indicate a destination, waypoint, or various other tasks associated with FMC client 160 operation, and have such inputs be processed to communicate with the FMS management module 150 to execute an application or service including the execution of automatic flight control functions or guidance instructions in cooperation with operation of any or all of the flight control/guidance module 350, the navigation module 360 and the instrumentation module 370. In some cases, the user interface 330 may be used to update or modify information indicative of various travel context details about the aircraft 100. For example, the travel context details may include information such as the aircraft tail number, departure time/location, destination, arrival time, airline, airframe configuration, aircraft weight, flight path intent and objective, weather information, route optimization factors, network identification information, hardware identification information, etc.

The flight control/guidance module 350 may receive sensor information from a sensor array of the aircraft 100 and, dependent on the mode of operation (i.e., autopilot or manual control), may either automatically move or control various flight control surfaces or may display guidance instructions to the pilot that are aimed at achieving the desired outcomes for the aircraft 100. The instrumentation module 370 may be either an electromechanical or an electronic flight instrument system for displaying aircraft status information, and for displaying the results of FMS aircraft control. The navigation module 360 may be configured to continuously calculate aircraft position and the position information may be continuously provided to the FMS management module 150 for processing relative to flight plan information that is processed at the FMS management module 150 for display during operation in the airborne thin client configuration of the FMC client 160 so that processing of aircraft position information can be done remotely relative to the NDB data stores that are located also remotely at the FMS management module 150. For DUWA configuration, the navigation module 360 may provide the aircraft position to the FMC client 160 for processing relative to navigational aids and flight plan information (limited to the present flight or perhaps also a subsequent flight) that is stored in the memory 314.

Thus, regardless of whether the FMC client 160 is structured in the airborne thin client configuration or in the DUWA configuration, the memory storage requirements on the aircraft 100 can be drastically smaller, lighter and less costly. Moreover, the updating of NDB and other FMS data can happen in a secure manner, even while the aircraft 100 is in flight. However, particularly when the airborne thin client configuration is employed, the reduction in the reliance on the storage of massive amounts of NDB and other FMS data, and the requirement for processing capabilities to handle such information in the air, can further enable the provision of otherwise memory and/or processing intensive services to be provided to the airborne thin client. Accordingly, as discussed briefly above, the provision of some additional services may also be enabled by virtue of example embodiments. For example, in some embodiments, cost index information related to flight plan optimization for minimization of fuel burn can be stored in the data management module 250. The processing circuitry 210 of the FMS management module 210 may therefore handle the heavy processing load of determining fuel burn profiles that maximize or optimize cost savings for flying a given flight path. Thus, for example, a fuel burn optimization application may be stored in the data management module 250 and executed at the FMS management module 150 while instructions associated therewith and correlation with NDB data and other FMS operations managed by the FMS management module 150 may also be executed at the processing circuitry 210 for service of content (via the distribution module 260) to the FMC client 160. The FMC client 160 may then serve the content to the pilot (or crew) on the aircraft 100, but the processing and memory used for generating the content is mainly instantiated on the ground, where there are less restrictions. As stated above, this is enabled by the provision of a two way, robust and reliable wireless link to the aircraft. The service of content may include either automatically operating control surfaces of the aircraft 100, or suggesting operation of the control surfaces of the aircraft 100 based on the guidance generated due to operation of the fuel burn optimization application. Content that can be provided to the FMC client 160 in flight may also (using either the thin client or DUWA paradigm) update software, firmware, and/or Operating System wirelessly from the FMS management module 150. Similarly, content or services may include a required time of arrival application, a minimized flight path length, time, or total cost application, a minimized engine warrantee cost minimization application, and a cost index management application.

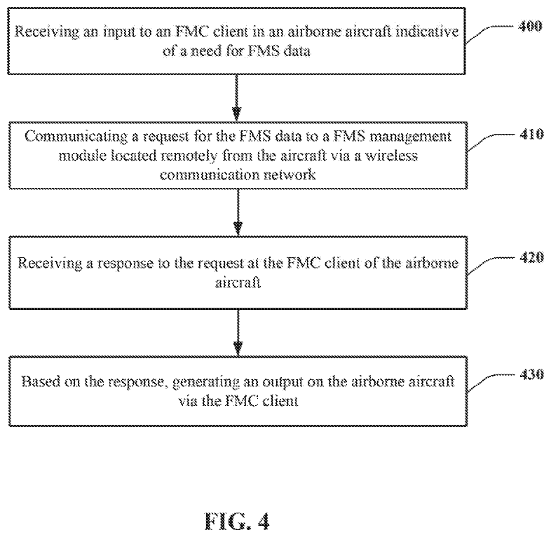

FIG. 4 illustrates a block diagram of one method that may be associated with an example embodiment as described above. From a technical perspective, the processing circuitry 210/310 described above may be used to support some or all of the operations described in FIG. 4. As such, the platforms described in FIGS. 1-3 may be used to facilitate the implementation of several computer program and/or network communication-based interactions. As an example, FIG. 4 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a device (e.g., the processing circuitry 210/310, and/or the like) and executed by a processor in the device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 4, may include receiving an input to an FMC client in an airborne aircraft indicative of a need for FMS data at operation 400. The method may further include communicating a request for the FMS data to a FMS management module located remotely (e.g., on the ground) from the airborne aircraft via a wireless communication network at operation 410, and receiving a response to the request at the FMC client of the airborne aircraft via the wireless communication network at operation 420. The method may further include, based on the response, generating an output on the airborne aircraft via the FMC client at operation 430. In some cases, these operations may follow an initial operation of receiving the NDB information or an update to the NDB information for storage at the FMS management module from an authorized entity.

Thus, in accordance with an example embodiment, a cloud-based flight management system may be provided. The system may include an FMS management module operably coupled to a wireless communication network on the ground, and an FMC client disposed at an aircraft including radio equipment configured to communicate via the wireless communication network while the aircraft is in flight. The FMS management module is configured to store FMS data including at least NDB information. At least some of the FMS data may be provided from the FMS management module to the FMC client while the aircraft is in flight. Additionally, either one of, multiple ones of, or each of software, firmware, and Operating System may be updateable wirelessly from the FMS management module to the FMC client while in flight.

In some embodiments, the system may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the FMC client may be an airborne thin client configured to receive content associated with processing of the FMS data on the ground while the aircraft is in flight. In an example embodiment, the FMS data may include a fuel burn optimization application. In some cases, responsive to entry of destination or waypoint information at the FMC client, NDB information may be communicated from the FMS management module to the FMC client. In an example embodiment, the NDB information may be stored at the FMS management module by an authorized entity. In some cases, the authorized entity may further provide a list of aircraft identifiers or tail numbers that are authorized recipients of the NDB information. In an example embodiment, the system may further include a security module configured to require authentication for modifications to the NDB information, and require authentication of requests for the NDB information, and require confirmation of receipt of the NDB information. In some cases, the security module may be configured to encrypt communications the FMS management module and the FMC client. In an example embodiment, the wireless communication network may include an ATG network configured to provide a bidirectional, high bandwidth link between the FMS management module and the FMC client. In some cases, the ATG network may be configured to provide a download speeds to the aircraft of greater than 4 Mbps and an upload speed from the aircraft of greater than 1 Mbps along with latency of less than 100 ms. In an example embodiment, the ATG network may communicate FMS data between the FMS management module and the FMC client in real time while the aircraft is in flight.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A cloud-based flight management system comprising:
a flight management system (FMS) management module operably coupled to a wireless communication network on the ground; and
a flight management computer (FMC) client disposed at an aircraft including radio equipment configured to communicate via the wireless communication network while the aircraft is in flight,
wherein the FMS management module is configured to store FMS data including at least navigation database (NDB) information,
wherein the software, firmware, and Operating System are updateable wirelessly, and
wherein at least some of the FMS data is provided from the FMS management module to the FMC client while the aircraft is in flight.

2. The system of claim 1, wherein the FMC client is an airborne thin client configured to receive content associated with processing of the FMS data on the ground while the aircraft is in flight.

3. The system of claim 2, wherein the FMS data includes the following objectives:
a fuel burn optimization application,
a Required Time of Arrival application,
a minimized flight path length, time, or total cost application,
a minimized engine warrantee cost minimization application, and
a Cost Index management application.

4. The system of claim 1, wherein, responsive to entry of destination or waypoint information at the FMC client, NDB information is communicated from the FMS management module to the FMC client.

5. The system of claim 4, wherein the NDB information is stored at the FMS management module by an authorized entity.

6. The system of claim 5, wherein the authorized entity further provides a list of aircraft identifiers or tail numbers that are authorized recipients of the NDB information.

7. The system of claim 5, wherein the system further comprises a security module configured to require authentication for modifications to the NDB information, and require authentication of requests for the NDB information, and require confirmation of receipt of the NDB information.

8. The system of claim 7, wherein the security module is configured to encrypt communications the FMS management module and the FMC client.

9. The system of claim 1, wherein the wireless communication network comprises an air-to-ground (ATG) network configured to provide a bidirectional, high bandwidth link between the FMS management module and the FMC client.

10. The system of claim 9, wherein the ATG network is configured to provide a download speeds to the aircraft of greater than 4 Mbps and an upload speed from the aircraft of greater than 1 Mbps along with latency of less than 100 ms.

11. The system of claim 1, wherein the ATG network communicates FMS data between the FMS management module and the FMC client in real time while the aircraft is in flight.

12. A method of providing a cloud-based flight management system (FMS), the method comprising:
receiving an input to a flight management computer (FMC) client in an airborne aircraft indicative of a need for FMS data;
communicating a request for the FMS data to a FMS management module located remotely from the airborne aircraft via a wireless communication network;
receiving a response to the request at the FMC client of the airborne aircraft via the wireless communication network; and
based on the response, generating an output on the airborne aircraft via the FMC client.

13. The method of claim 12, wherein receiving the response comprises receiving guidance based on a fuel burn optimization application executed at the FMS management module and served to the FMC client.

14. The method of claim 13, wherein generating the output comprises operating control surfaces of the aircraft or suggesting operation of the control surfaces of the aircraft based on the guidance.

15. The method of claim 11, wherein receiving an input to the FMC client comprises receiving entry of destination or waypoint information at the FMC client, and
wherein the request includes a request for NDB information based on the destination or waypoint information.

16. The method of claim 12, further comprising an initial operation of receiving the NDB information or an update to the NDB information for storage at the FMS management module from an authorized entity.

17. The method of claim 16, wherein receiving the NDB information or the update to the NDB information further comprises receiving a list of aircraft identifiers or tail numbers that are authorized recipients of the NDB information.

18. The method of claim 19, wherein communicating the request and receiving the response each further include requiring authentication of a sender of the request and a sender of the response.

19. The method of claim 18, wherein the request and the response are each encrypted.

20. The method of claim 12, wherein the wireless communication network comprises an air-to-ground (ATG) network configured to provide a bidirectional, high bandwidth link between the FMS management module and the FMC client.
